(19) United States
(12) Patent Application Publication
(10) Pub. No.: US 2006/0290685 A1
(43) Pub. Date: Dec. 28, 2006

(54) MULTICOLORED LIGHTING DEVICE AND COORDINATE INPUT DEVICE

(75) Inventor: Hideaki Nagakubo, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/422,853

(22) Filed: Jun. 7, 2006

(30) Foreign Application Priority Data
Jun. 23, 2005 (JP) 2005-183064

(51) Int. Cl. G09G 5/00

(52) U.S. Cl. 345/175

(57) ABSTRACT

Provided is a multicolored lighting device capable of illuminating an operation surface with high efficiency and high quality and a coordinate input device. Themulticolored light sources are disposed in the vicinity of the edges of a bar-shaped light guide having a plurality of chromatic light sources. The chromatic light sources are symmetrically disposed with respect to the bar-shaped light guide.

### BACKGROUND

1. Field

A multicolored lighting device and a coordinate input device is provided, and more particularly, a multicolored lighting device and a coordinate input device with high lighting quality.

2. Related Art

Conventionally, in a portable computer terminal device such as a laptop computer, a coordinate input device called a touch pad is mounted. This touch pad is a pointing device for operating a cursor or a pointer displayed on a screen of the terminal device, similar to a mouse. When a user's finger or a pen tip comes in contact with an operation surface, a contact point is detected by a sensor and the cursor or the pointer is operated according to a coordinate value of the contact point or displacement of the coordinate value due to movement of the contact point.

In such a coordinate input device, the sensor includes a sheet having an optical transmission property and a backlight-attached color liquid crystal display (LCD) panel is disposed below the sensor to illuminate the operation surface.

[Patent Document 1] Japanese Unexamined Patent Application Publication No. 2003-99187

However, in the coordinate input device, since the backlight-attached color LCD panel is disposed below the sensor, the light of the backlight transmits through the color LCD and the sensor to be emitted to an external world. Accordingly, since the light of the backlight is absorbed into the LCD or the sensor, sufficient light amount cannot be obtained. In addition, since the sensor is made of a material having the optical transmission property, the cost increases.

### SUMMARY

A multicolored lighting device capable of illuminating an operation surface with high efficiency and high quality and a coordinate input device is provided.

The multicolored lighting device includes: a bar-shaped light guide having a pair of first edges for receiving light and a side surface for emitting the light. A pair of multicolored light sources are disposed in the vicinity of the pair of first edges. A light guide having a pair of main surfaces that face each other and a second edge for receiving the light emitted from the side surface, wherein the pair of multicolored light sources has a plurality of chromatic light sources, and, in the pair of multicolored light sources, the chromatic light sources having a same color are symmetrically disposed with respect to the bar-shaped light guide.

By this configuration, since the chromatic light sources in the multicolored light sources are symmetrically disposed with respect to the bar-shaped light guide, the illuminated light from the horizontally symmetrical multicolored light sources enters into the bar-shaped light guide having the horizontally symmetrical prism such that reflection of the light in the bar-shaped light guide and the light focusing balance (mixed-color light emitting property upon simultaneous lighting) are stabilized and light emitting quality is improved. As a result, it is possible to obtain good color tone of the illuminated light and to prevent brightness unevenness of the illuminated light.

In the multicolored lighting device, the bar-shaped light guide may have a reflection member on a side surface facing the side surface.

In another embodiment, a coordinate input device includes: an operation surface which is operated by a coordinate indicator and the multicolored lighting device for illuminating the operation surface according to the previous embodiment.

Since a multicolored lighting device includes a bar-shaped light guide having a pair of first edges for receiving light and a side surface for emitting the light; a pair of multicolored light sources which is disposed in the vicinity of the pair of first edges; and a light guide having a pair of main surfaces that face each other and a second edge for receiving the light emitted from the side surface. The pair of multicolored light sources has a plurality of chromatic light sources. In the pair of multicolored light sources, the chromatic light sources having a same color are symmetrically disposed with respect to the bar-shaped light guide, an operation surface can be illuminated with high efficiency and high quality.

### BRIEF DESCRIPTION OF THE DRAWINGS

FIG. 1 is an exploded perspective view showing a multicolored lighting device;

FIG. 2 is a plan view showing a bar-shaped light guide of the multicolored lighting device shown in FIG. 1;

FIG. 3 is a plan view showing the bar-shaped light guide of the multicolored lighting device shown in FIG. 1;

FIG. 4 is a plan view showing another bar-shaped light guide in the multicolored lighting device;

FIG. 5 is a view showing a schematic configuration of a glide point device including the multicolored lighting device;

FIG. 6 is a view showing an internal configuration of a PC body in the glide point device shown in FIG. 5; and

FIG. 7 is a view showing an internal configuration of a sensor in the glide point device shown in FIG. 5.

### DESCRIPTION OF THE PREFERRED EMBODIMENT

Hereinafter, embodiments will be described in detail with reference to the attached drawings.

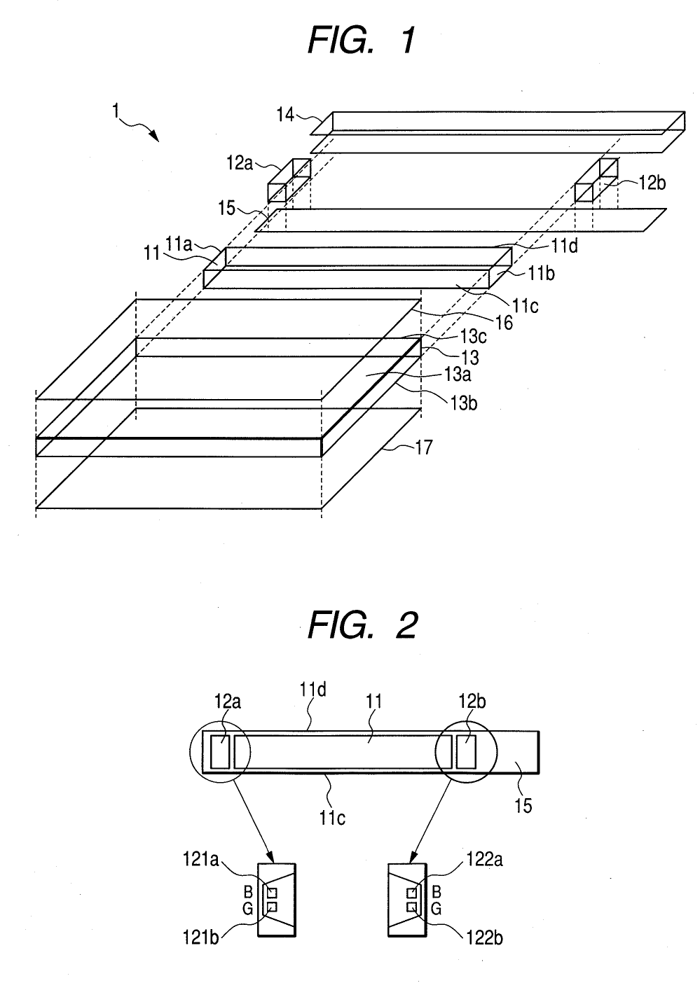

FIG. 1 is an exploded perspective view showing a multicolored lighting device. A multicolored lighting device 1 shown in FIG. 1 mainly includes a transparent bar-shaped light guide 11 having an elongate rectangular parallelepiped shape, multicolored light sources 12a and 12b for emitting light to an edge of the bar-shaped light guide 11, and a transparent light guide 13 for receiving the light from the bar-shaped light guide 11.

The bar-shaped light guide 11 includes a pair of edges 11a and 11b which is a first edge for receiving the light, a side surface 11c for emitting light which propagates in the bar-shaped light guide 11, and a side surface 11d facing the side surface 11c. The edges 11a and 11b face each other. The light from the multicolored light source 12a disposed in the vicinity of the edge 11a enters into the bar-shaped light guide 11 through the edge 11a, and the light from the multicolored light source 12b disposed in the vicinity of the edge 11b enters into the bar-shaped light guide 11 through the edge 11b. A prism is formed in the side surface 11d of the bar-shaped light guide 11 such that the light which propagates through the bar-shaped light guide 11 is directed to the side surface 11c. In addition, a reflector 14 which is a reflection member for returning the light emitted through the side surface 11d to the bar-shaped light guide 11 is disposed on the side surface 11d of the bar-shaped light guide 11. The reflector 14 has approximately a U-shaped cross-section and covers both main surfaces and the side surface 11d of the bar-shaped light guide 11. The reflector 14 is made of metal such as aluminum and has a metal thin film such as aluminum. In addition, a flexible printed circuit board (FPC) 15 for mounting the multicolored light sources 12a and 12b is disposed below the bar-shaped light guide 11.

The light guide 13 has a flat plate shape and includes a pair of main surfaces 13a and 13b which face each other and an edge 13c which is a second edge for receiving the light emitted from the side surface 11c of the bar-shaped light guide 11. The bar-shaped light guide 11 is provided in the vicinity of the edge 13c of the light guide 13 such that the side surface 11c of the bar-shaped light guide 11 is positioned along the edge 13c of the light guide 13. A prism is formed in one surface 13a of the light guide 13 (see FIG. 5) such that the light which propagates in the light guide 13 is emitted to an illuminated body, for example, a liquid crystal display panel or an operation surface of a coordinate input device such as a glide point device through the prism. A diffusion plate 16 is disposed above the main surface 13a of the light guide 13 and a reflection plate 17 is disposed below the main surface 13b.

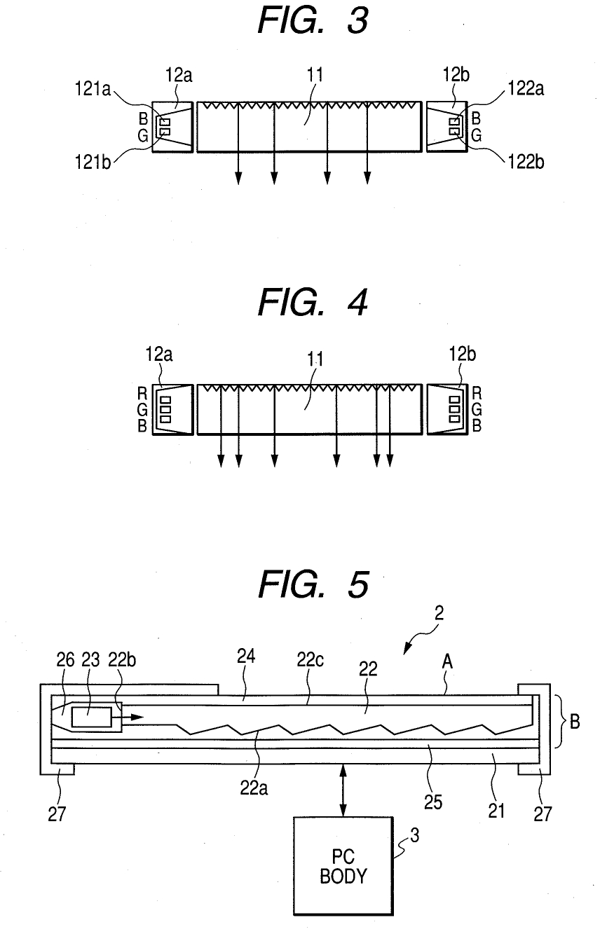

FIGS. 2 and 3 are plan views showing the bar-shaped light guide of the multicolored lighting device shown in FIG. 1. The multicolored light sources 12a and 12b disposed in the vicinity of the edges 11a and 11b of the bar-shaped light guide 11 have a plurality of monochromic light sources 121a, 121b, 122a, and 122b (two by two in FIG. 12). As the monochromic light sources 121a, 121b, 122a, and 122b, a light emitting diode (LED) or the like is used. The monochromic light sources 121a, 121b, 122a, 122b are symmetrically positioned with respect to the bar-shaped light guide 11. In other words, in the multicolored light source 12a, the blue (B) LED 121a is disposed on the side of the side surface 11d and the green (G) LED 121b is disposed on the side of the side surface 11c. Meanwhile, in the multicolored light source 12b, the blue (B) LED 122a is disposed on the side of the side surface 11d and the green (G) LED 122b is disposed on the side of the side surface 11c. In the multicolored light sources 12a and 12b, the blue (B) LED 121a and 122a are disposed on the side of the side surface 11d and the green (G) LED 122a and 122b are disposed on the side of the side surface 11c.

In the multicolored light sources 12a and 12b, since the chromatic light source 121a, 121b, 122a, and 122b are symmetrically positioned with respect to the bar-shaped light guide 11, the illuminated light from the multicolored light source enters into the horizontally symmetrical bar-shaped light guide 11 having the horizontally symmetrical prism such that reflection of the light in the bar-shaped light guide 11 and light focusing balance (mixed-color light emitting property upon simultaneous lighting) is stabilized to improve light emitting quality. As a result, it is possible to obtain good color tone of the illuminated light and to prevent brightness unevenness of the illuminated light. Meanwhile, although, in the above description, the multicolored light sources 12a and 12b have the two monochromic light sources 121a and 121b and the two monochromic light sources 122a and 122b, respectively, the present embodiment is similarly applicable to a case where the multicolored light source has at least three monochromic light sources. In other words, as shown in FIG. 4, although the multicolored light source has three monochromic light sources, the monochromic light sources are symmetrically disposed with respect to the bar-shaped light guide, thereby obtaining the same effect.

Next, a case where the multicolored lighting device is used for a glide point device which is the coordinate input device will be described. FIG. 5 is a view showing a schematic configuration of a glide point device including the multicolored lighting device.

A glide point device 2 shown in FIG. 5 is electrically connected to a personal computer (PC) body 3 which performs pointing by an input using the glide point device 2. Meanwhile, the glide point device 2 is embedded in the PC body 3.

The glide point device 2 includes a sensor 21 which is a detecting means for detecting an operation state on an operation surface A by a coordinate indicator and a front light B which is multicolored lighting device for illuminating the operation surface A and is provided on the sensor 21. The front light B has the above-described configuration, and includes a light guide 22 having a flat plate shape and having a prism surface 22a on the side of the sensor 21, a bar light guide and a multicolored light source 23 disposed in the vicinity of the edge 22b of the light guide 22, and a diffusion plate 24 disposed on a flat surface 22c on the opposite side of the prism surface 22a of the light guide 22.

A reflection plate 25 is disposed between the sensor 21 and the prism surface 22a of the light guide 22. In addition, the bar-shaped light guide and the multicolored light source 23 are covered with a reflector 26. Furthermore, the both ends of the sensor 21 and the front light B are integrally fixed by a fixing frame 27. Meanwhile, the multicolored light source 23 includes monochromic light sources which are symmetrically disposed with respect to the bar-shaped light guide, as shown in FIG. 3.

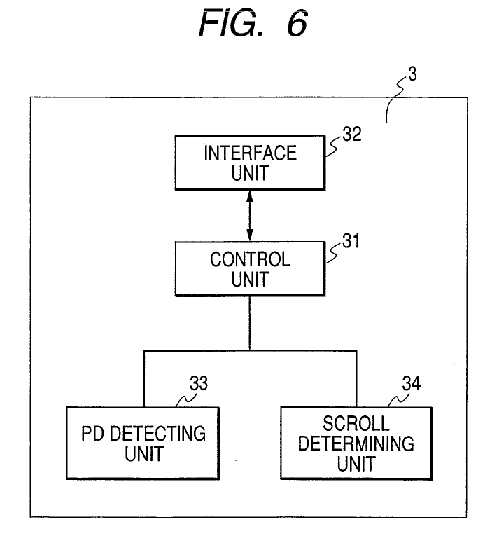

FIG. 6 is a view showing an internal configuration of the PC body in the glide point device shown in FIG. 5. The PC body 3 shown in FIG. 6 includes a control unit 31 for controlling the overall units of the device, an interface unit 32 which is a communication port for performing communication among the units, a PD detecting unit 33 for detecting whether a pointing device (PD) such as a mouse is mounted in the PC body 3, and a determining unit 34 for determining a scroll operation of the PD or the coordinate input device 1. Meanwhile, the PC body 3 includes a general computer function and includes a process unit included in the general computer except the above-described units.

The PD detecting unit 33 detects that the PD is connected to the PC body 3 and the PD can be operated in cooperation with the PC body 3. The scroll determining unit 34 determines whether the scroll operation is performed on a screen of the PC body 3 according to a control signal from the below-described sensor board and performs the scroll.

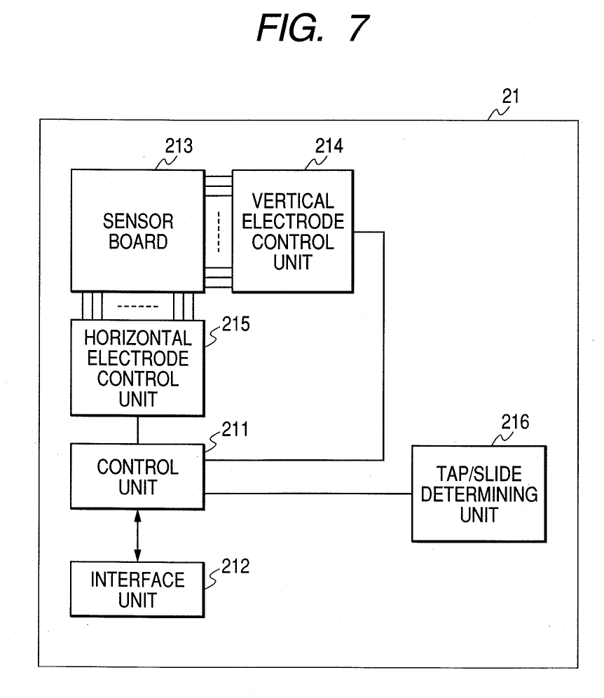

FIG. 7 is a view showing an internal configuration of the sensor in the glide point device shown in FIG. 5. The sensor 21 shown in FIG. 7 includes a control unit 211 for controlling the overall units of the device, an interface unit 212 which is a communication port for performing communication among the units, a sensor board 213, a vertical electrode control unit 214 for controlling vertical electrodes connected to the sensor substrate, a horizontal electrode control unit 215 for controlling horizontal electrodes connected to the sensor board 213, and a tap/slide determining unit 216 for determining whether an tap operation or a slide operation is performed on the operation surface A.

The sensor board 213 shown in FIG. 7 includes a plurality of vertical electrodes and a plurality of horizontal electrodes, which are disposed on a front surface or a rear surface of a film, respectively. The vertical electrodes and the horizontal electrodes are disposed in a matrix. When a user's finger comes in contact with the operation surface of the glide point device 2 having the sensor board 213 having the above-described configuration, capacitance of the contact portion of the sensor board 213 is reduced. The change in capacitance is converted into change in current value to detect the change amount of each electrode. The position of the finger is detected by the change amount of each electrode in a vertical direction and a horizontal direction. Meanwhile, although the sensor board 213 is configured in a capacitive manner, the sensor board 213 may be configured in the other manner such as a pressure-sensitive manner.

The vertical electrode control unit 214 is a circuit for vertically scanning the sensor board 213 and generates a serial detection signal representing a scan state of the user's finger. The serial detection signal includes a tap component which is generated when tapping the finger on the operation surface A of the sensor board 213 and a slide component which is generated when sliding the finger on the operation surface A. The horizontal electrode control unit 215 is a circuit for horizontally scanning the sensor board 213. The tap component includes an address component representing a position in which the finger is in contact with the operation surface A and the slide component includes an address component representing positions from and to where the finger slides to be moved on the operation surface A.

The tap/slide determining unit 216 determines whether the tap operation or the slide operation is performed.

The user puts his/her finger on an area (operation surface) of the diffusion plate 24 corresponding to the sensor 21 of the glide point device 2 having the above-described configuration and slides his/her finger such that the cursor (or the pointer) can be moved on the screen of the PC body 3. In addition, by lightly tapping the finger on the operation A (tap operation), it is possible to realize various operations such as selection or movement of an object displayed on the screen, similar to click of a left button of the mouse. In addition, by tapping the finger on the operation surface A twice, it is possible to realize an operation such as start-up of an application, similar to double click of the mouse. Furthermore, when the tap operation is performed in a state that the cursor is put on an object on the screen and then moved (slide operation and drag operation), the tap/slide determining unit 216 determines which operation is performed and moves the object to a desired place in the PC body 3 according to the determined information. In addition, in the operation surface A, a scroll bar area is provided. By sliding the finger in the scroll bar area (scroll operation), it is possible to realize scroll of the screen.

A case where the operation surface A of the glide point device 2 having the above-described configuration is illuminated will be described. First, referring to FIGS. 1 and 2, the light emitted from the multicolored light sources 12a and 12b enters into the bar-shaped light guide through the edges 11a and 11b of the bar-shaped light guide 11. In the bar-shaped light guide 11, the light emitted from the chromatic light sources 121a, 121b, 122a, and 122b propagates while being reflected. Since the prism is formed in the side surface 11d of the bar-shaped light guide 11 and the top and the bottom of the bar-shaped light guide 11 is covered with the reflector 14, the path of the light which reaches the side surface 11d is changed such that the light is directed to the side surface 11c (light guide 13). In addition, the light emitted from the top and the bottom of the bar-shaped light guide 11 returns into the bar-shaped light guide 11 by the reflector 14. The light which returns into the bar-shaped light guide 11 propagates in the bar-shaped light guide 11 and the path thereof is changed by the prism such that the light is directed to the side surface 11c (light guide 13). The light emitted from the multicolored light sources 12a and 12b is transmitted from the bar-shaped light guide 11 to the light guide 13 through the edge 13c of the light guide.

Subsequently, referring to FIG. 5, the light received from the bar-shaped light guide through the edge 22b propagates in the light guide 22. When the light propagates in the light guide 22 to reach the prism surface 22a, the light path is changed to the lower side and the light reaches the reflection plate 25. In addition, the light is reflected from the reflection plate 25 to be directed to the upper side. The light transmits through the light guide 13 to be emitted through the flat surface 22c to the upper side (the side of operation surface A). To this end, the light from the bar-shaped light guide enters into the light guide 22 through the edge 22b of the light guide 22, propagates in the light guide 22, and reflects from the reflection plate 25 to be directed to the operation surface A. Accordingly, the operation surface A is illuminated. Meanwhile, a base angle of the prism provided in the prism surface 22a of the light guide 22 is not specially limited if the light from the multicolored light sources can be directed to the operation surface A.

Since the glide point device 2 includes the front light B, that is, the lighting device is disposed on the sensor 21 and the other member is not disposed on the lighting device, the light of the lighting device can be efficiently used for illuminating the operation surface A. In addition, since the sensor 21 is disposed below the lighting device, the sensor 21 need not be made of a transparent material and thus is beneficial to a cost.

Furthermore, in the present embodiment, since the chromatic light sources in the multicolored light sources are symmetrically disposed with respect to the bar-shaped light guide, the illuminated light from the horizontally symmetrical multicolored light sources enters into the bar-shaped light guide 11 having the horizontally symmetrical prism such that reflection of the light in the bar-shaped light guide and the light focusing balance (mixed-color light emitting property upon simultaneous lighting) are stabilized and light emitting quality is improved. As a result, it is possible to obtain good color tone of the illuminated light and to prevent brightness unevenness of the illuminated light. In addition, it is possible to illuminate the operation surface A of the glide point device 2 with high light emitting quality.

The present invention is not limited to the above-described embodiments and may be variously changed. For example, members or materials are only exemplary and may be variously changed. Although, in the above-mentioned embodiments, the multicolored lighting device is the front light, the multicolored lighting device of the present invention may be a back light. The present invention can be adequately changed without departing from scope of the present invention.

What is claimed is:

1. A multicolored lighting device comprising:
a bar-shaped light guide having a pair of first edges that receive light and a side surface for emitting the light;
a pair of multicolored light sources that are disposed in the vicinity of the pair of first edges; and a light guide having a pair of main surfaces that face each other and a second edge that receive the light emitted from the side surface,
wherein the pair of multicolored light sources has a plurality of chromatic light sources, wherein in the pair of multicolored light sources, the chromatic light sources having a same color are symmetrically disposed with respect to the bar-shaped light guide.

2. The multicolored lighting device according to claim 1, wherein each of the chromatic light sources is a light emitting diode.

3. The multicolored lighting device according to claim 1, wherein the bar-shaped light guide has a reflection member on a side surface facing the side surface.

4. The multicolored lighting device according to claim 1, wherein the bar-shaped light guide has a prism in one of the side surfaces.

5. A coordinate input device comprising:
an operation surface that is operated by a coordinate indicator; and
the multicolored lighting device for illuminating the operation surface which is disposed below the operation surface according to claim 1.

6. The coordinate input device according to claim 5, wherein a reflection plate is disposed below the multicolored lighting device.
